(19) United States
(12) Patent Application Publication
(10) Pub. No.: US 2009/0094736 A1
(43) Pub. Date: Apr. 16, 2009

(54) Whirlpool jet with improved cutoff switch

(76) Inventors: John William Booth, Irving, TX (US); Michael C. Dinsdale, Richardson, TX (US)

Correspondence Address: PGM;Philip G. Meyers Law Office, Suite 300, 1009 Long Prairie Road, Flower Mound, TX, 75022, US

(21) Appl. No.: 11/974,188

(22) Filed: Oct. 12, 2007

(51) Int. Cl. A61H 33/00

(52) U.S. Cl. 4/541.6

(57) ABSTRACT

A jet for use in a whirlpool tub or spa according to a first aspect of the invention includes a motor assembly including an electric motor disposed inside a motor housing, which motor housing includes a frontwardly facing, water-tight recess. Suitable means are provided for mounting the motor assembly in a hole in a tub wall. A centrifugal pump assembly used in the jet includes a rotor-impeller having a rear, magnetically attractable rotor disposable in the recess of the motor assembly and a front set of blades. A cover having water inlet and outlet openings is removably securable over the rotor-impeller. A sensor system is provided which can be connected to the motor to shut off the motor when the cover is removed from the centrifugal pump assembly. The sensor system includes a sensor target disposed on a rear surface of the cover, and a sensor disposed on or near the pump assembly, such that the sensor detects the sensor target only when the cover is secured over the centrifugal pump assembly in one or more predetermined positions.

The invention relates to whirlpool bathtub jet apparatus of the type wherein one or more jet assemblies are installed in a tub wall.

### BACKGROUND OF THE INVENTION

Whirlpool jets of the type used in spas and bathtubs are used to recirculate water inside the tub or spa, with or without injection of air. For this purpose, the jet assembly is set in a hole in the tub wall and powered by an electric motor that drives an impeller. Recently, “pipeless” jets have become popular wherein the jet draws water into a chamber inside the unit, redirects its flow in a radial or lateral direction, and then ejects it from one or more nozzles, without the use of a pipe that carries water from an inlet to an outlet location on the tub wall. See Jaworski U.S. Pat. No. 4,853,987 and Booth U.S. Pat. Nos. 5,414,878 and 5,587,023. A plastic cover or escutcheon plate covers the mouth of the jet, and in many designs provides openings for the intake opening(s) and outlet nozzle.

The inlet and outlet positions will depend on the type of centrifugal pump being used. In a mixed flow pump, the nozzle is located at or near the center with the intake openings around the outside of the cover plate. In a radial flow pump, the intake is at the center with nozzles on the outside, depending on the arrangement of the impeller and the casing enclosing it.

Most pipeless jets are driven by an electric motor positioned behind the water circulation chamber. The impeller can be driven by a drive shaft that extends through a water tight hole in the back wall of the chamber, as shown in the Booth patents cited above. To avoid the need for a drive shaft that penetrates the plastic pump housing, more recent jet designs provide the impeller with a magnetic rotor that is positioned so that the impeller can be driven directly by the magnetic field created by the electric motor's stator, which field extends through the rear wall of the water chamber.

Known spa jets have also used Hall effect sensors or switches for purposes of allowing a user to control the jet, or to monitor the state of the impeller. See, for example, U.S. Pat. Nos. 5,983,416 and 6,295,662. In a prior art jet assembly sold by Sanijet Corporation known as the 30008, the pump housing was of the mixed-flow type. It included an escutcheon outer pump housing section attached to the inside of the escutcheon, an impeller and an inner pump housing section which fit together with the outer pump housing section. This pump assembly was removed as a unit for cleaning. It proved cumbersome in this device to provide an interlock that would turn the pump motor off when the pump housing had been removed. A magnet was housed in a molded plastic projection on the outer pump housing section, the inner section had a tubular holder on its outside for housing a metal flux pin. When the pump housing sections were secured together, the magnet and flux pin are aligned with each other. When pump assembly was then inserted into the pump casing, the magnet and flux pin aligned with a hall effect sensor positioned behind inner housing section.

The sensor sent a signal indicating when all components were correctly installed, otherwise the pump motor would not run. However, it was not of great utility from a safety standpoint. In such a mixed flow pump where the impeller is enclosed in a housing and is removed at the same time as the cover, there is no danger that the impeller will run when the device has been disassembled. Sensor responsiveness was an issue because the magnet was spaced from the sensor and a flux pin had to be interposed between them. The present invention addresses these and other limitations.

Pipeless jet assemblies can be potentially hazardous in certain situations. If a bather's hair becomes caught in the jet while it is running, the bather could drown. Many jet designs permit the cover to be removed manually for purposes of cleaning. However, injury could result if the cover is removed while the impeller is running. A pipeless jet marketed by Lexor Inc. has a plastic housing that covers the blades from the front of the impeller, so that the blades are only exposed around the side where water is ejected circumferentially. These covered blades also are more difficult to clean. The present invention addresses these drawbacks.

### SUMMARY OF THE INVENTION

A jet for use in a whirlpool tub or spa according to a first aspect of the invention includes a motor assembly including an electric motor disposed inside a motor housing, which motor housing includes a frontwardly facing, water-tight recess. Suitable means are provided for mounting the motor assembly in a hole in a tub wall, including the 3-piece mounting system set forth in the detail description hereafter, as well as others known in the art, such as using J-latch assemblies as shown in the foregoing Booth patents, or use of external threads on the pump housing and a threaded plastic ring mounted thereon, which is tightened to clamp the jet to the tub wall. A centrifugal pump assembly used in the jet includes a rotor-impeller having a rear, magnetically attractable rotor disposable in the recess of the motor assembly and a front set of blades. A cover having water inlet and outlet openings is removably securable over the rotor-impeller. A sensor system is provided which can be connected to the motor to shut off the motor when the cover is removed from the centrifugal pump assembly. The sensor system includes a sensor target disposed on a rear surface of the cover, and a sensor disposed on or near the pump assembly, such that the sensor detects the sensor target only when the cover is secured over the centrifugal pump assembly in one or more predetermined positions. Known centrifugal pumps used in spa jets lack such a sensor system but have a much more acute need for it than mixed flow pumps wherein the blades are removed at the same time as cover, making it impossible for the user to be injured by the uncovered blades.

According to a further aspect of the invention, two or more sensor targets are provided such that the sensor detects one of the sensor targets only when the cover is secured over the centrifugal pump assembly in two or more predetermined positions. The cover has a plurality of small water inlet openings distributed about its surface, and one or more off-center outlet openings. By repositioning the cover, the user can vary the water flow direction from the outlet opening depending on which predetermined position the cover is secured in. If more than one outlet opening or nozzle is provided in the cover, then this embodiment of the invention requires that these not be placed so symmetrically that changing from one predetermined position to another causes the outlet openings to exchange positions and thereby does not result in any change in water flow in the tub.

The invention further provides an improved system for mounting a motor assembly in a tub wall that uses detents instead of threads. These and other aspects of the invention are further discussed in the detailed description that follows.

### BRIEF DESCRIPTION OF THE DRAWINGS

In the accompanying drawings, wherein like numerals denote like elements:

FIG. 1 is a side view of a jet according to the invention installed in a tub wall, with the tub wall in section;

FIG. 2 is a front exploded view of the jet of FIG. 1, with the tub wall partly broken away;

FIG. 3 is a rear exploded view of the motor assembly shown in FIG. 2;

FIG. 4 is an enlarged view of the clamp ring and flange bushing shown in FIG. 2;

FIG. 5A is a partial sectional view of the bushing and clamp ring shown in FIG. 4 in an unlocked position, after insertion of the clamp ring into the bushing;

FIG. 5B is the same view as FIG. 5A, with the components in a locked position;

FIG. 6 is a front view of the jet shown in FIG. 1;

FIG. 7 is a sectional view taken along the line 7-7 in FIG. 6;

FIG. 8 is an exploded rear view of the cover, flow guide and rotor-impeller of FIG. 2;

FIG. 9 is a back view of the cover and flow guide of FIG. 8, assembled;

FIG. 10 is a sectional view taken along the line 10-10 in FIG. 9; and

FIGS. 11A and 11B are front views of two jet arrangements according to the invention.

### DETAILED DESCRIPTION

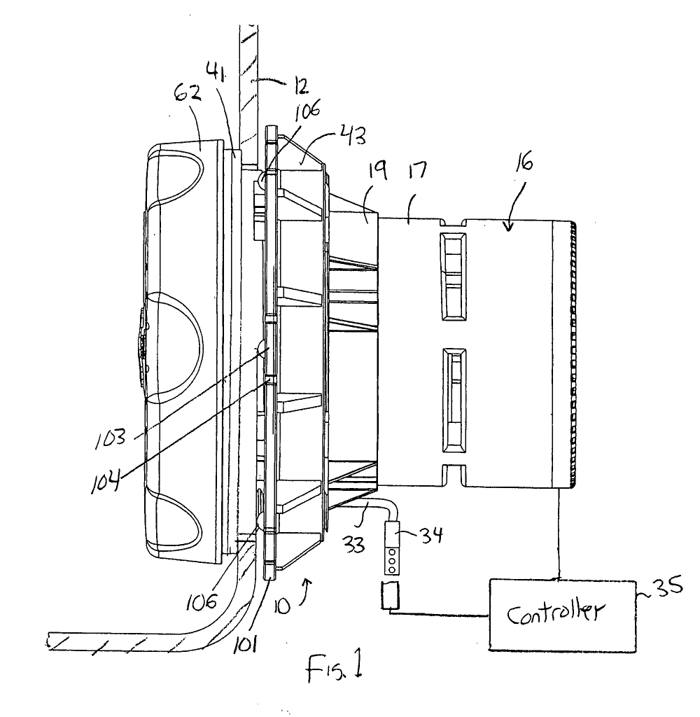

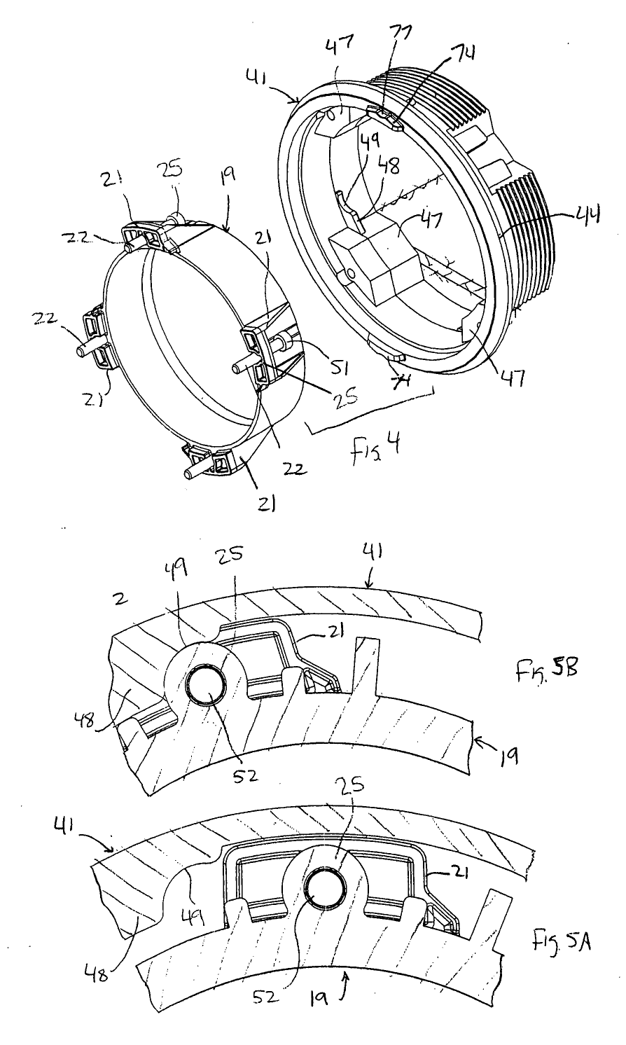

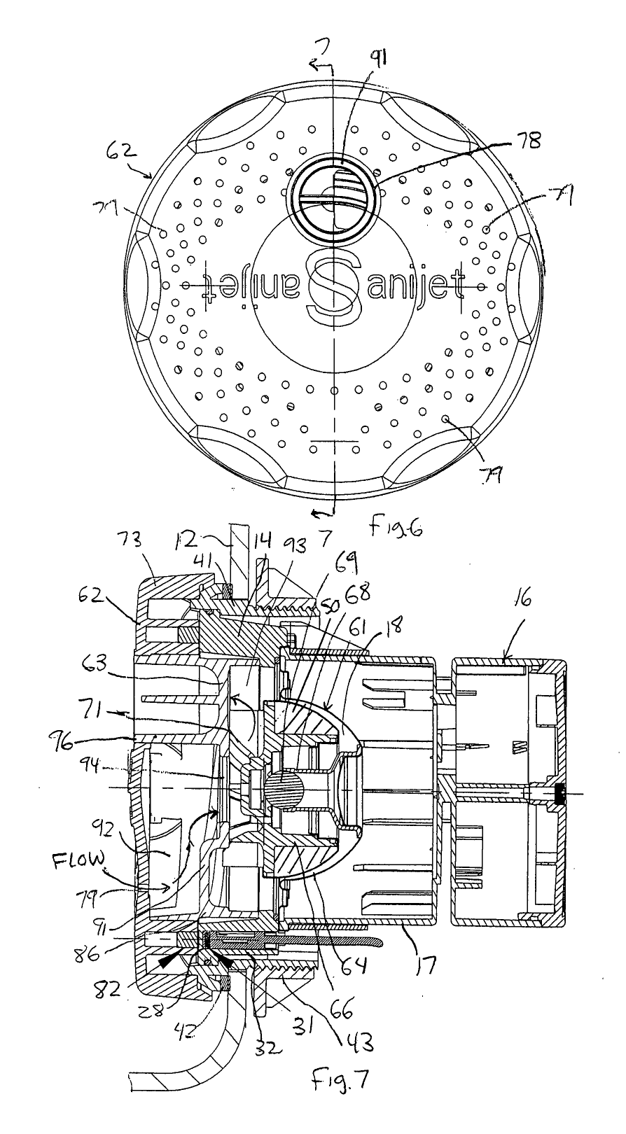

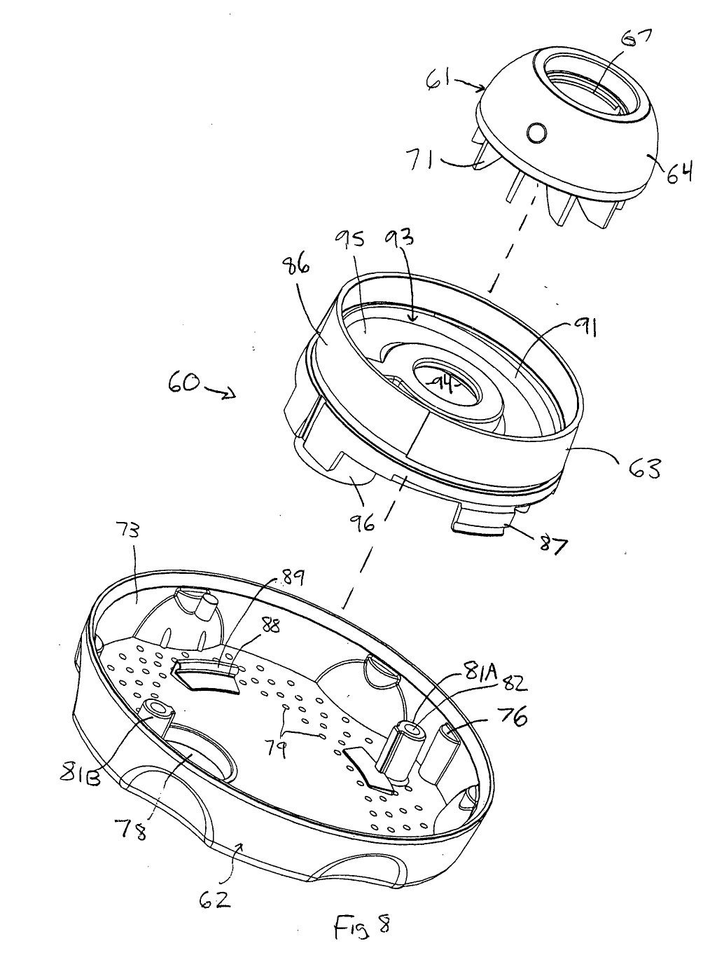

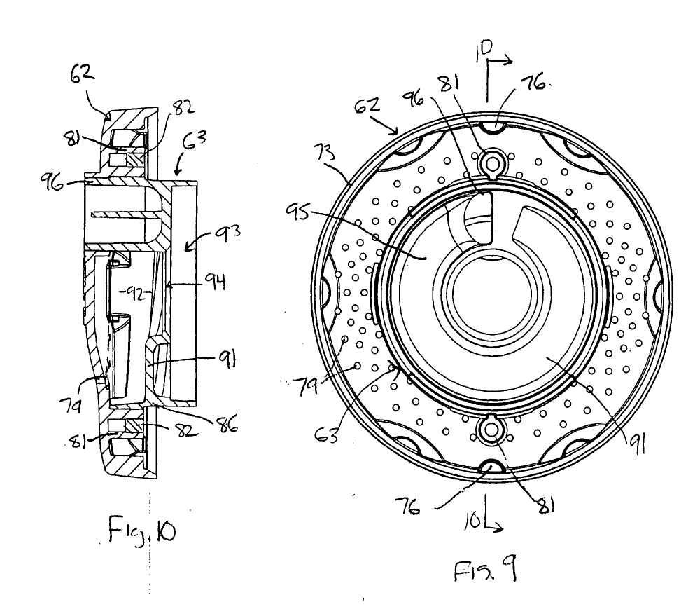

Referring to FIGS. 1 to 3, a whirlpool jet 10 according to the invention is configured for mounting in a hole 11 in the side of a tub wall 12. The jet 10 includes a motor assembly 15 wherein a plastic annular pump case 14 has an electric motor 16 coupled to its rear end. A DC motor is used in this example but an AC motor could be used. Motor 16 has a plastic tubular housing 17 which is sealed and capped at both ends. A front stainless steel end cap of housing 17 has a concave interior recess 18 in which water from the tub will circulate. Housing 17 is secured to case 14 by means of a clamp ring 19 having four radial flanges 21 having holes 51 through which retainer screws 22 extend. Clamp ring 19 slides over the rear end of housing 17 and has a front edge 23 that engages an outwardly directed rim 24 at the front of housing 17. Once so engaged, screws 22 are set in rearwardly opening threaded holes in cylindrical projections 25 on the back of pump case 14, whereby motor 16 is clamped between case 14 and ring 19. To render the assembly water-tight, a first, smaller diameter elastomeric O-ring 26 is positioned in a rearwardly facing annular groove 29 in pump case 14. A second, larger diameter O-ring 27 fits in an annular groove 30 on a front rim 28 of case 14.

An interlock sensor 31, preferably a Hall effect switch or sensor, is set in a rearwardly opening socket 32 in case 14 so that its front end is close to the flat front surface of rim 28. A wire 33 ending in a connector 34 extends rearwardly for direction connection to motor 16, or a separate controller 35 for motor 16. Sensor 31 is used to cut power to motor 16 unless the presence of a magnet is detected in front of it as described further below.

Motor assembly 15 comprising case 14, motor 16 and clamp ring 19 is secured in hole 11 by means of a mounting system including a tubular flange bushing 41, gasket 42 and a lock ring 43. Gasket 42 is set behind a front radial rim 44 of bushing 41. Rim 44 has a greater diameter than hole 11, whereby gasket 42 is clamped against the inside of the tub wall 12 when an externally threaded, rear end portion 46 of bushing 41 is inserted fully into hole 11. Lock ring 43 is internally threaded and is threadedly coupled to end portion 46 on the outside of the tub, securing bushing 41, gasket 42 and lock ring 43 to hole 11. The assembly of case 14, motor 16 and ring 19 fit into the front end of bushing 41 into engagement with an inwardly directed lip 45 in front of shoulders 47 of bushing 41.

Referring to FIGS. 4, 5A and 5B, the invention provides an innovative system for mounting, removing and replacing the motor assembly 15 from the inside of the tub without need for access to the outside of the tub to secure the motor assembly in position. Four shoulders 47 are positioned 90° apart are shown, each of which has a circumferentially directed, integrally molded plastic tab 48 with a curved notch 49 in its distal end. The gaps between shoulders 47 provide pass-through clearance for tabs 21 of clamp ring 19. Screws 22 extend through four holes 51 at the centers of tabs 21. Upon initial insertion of the motor assembly into bushing 41, tabs 21 are behind and spaced from tabs 48 as shown in FIG. 5A. The installer then twists the motor assembly relative to bushing 41 secured to the tub wall 12 so that cylindrical projections 25 move towards tabs 48. Curved notches 49 are profiled such that the ends of tabs 48 must resiliently deform in order to snap-fit each projection 25 into its notch 49, assuming the position shown in FIG. 5B. When motor assembly 15 is rotated into the detent lock position, leading edges of tabs 21 pass behind tabs 48 to secure motor assembly 15 from axial pullout. This connection is engineered so that considerable force is needed to disengage projections 25 from notches 49, e.g. use of a spanner tool is required, making it unlikely that a user could accidentally disengage the unit during normal use.

A pump assembly 60 for use with the motor assembly 15 includes a centrifugal rotor-impeller 61, an outer escutcheon or cover 62, and a flow guide insert 63. Rotor-impeller 61 includes a hemispherical steel bowl or shell 64 which houses the rotor magnet 50. Shell 64 fits into concave interior recess 18. As shown in FIG. 7, a plastic internal frame 66 supports shell 64. Shell 64 has a rearwardly opening socket 67 that fits over a spindle 68 formed on concave recess 18 of motor housing 17. Spindle 68 is a hollow projection that terminates and secures a ceramic ball bearing 69 that is received in socket 67. Frame 66 supports rotor-impeller 61 for rotation on bearing 69 of spindle 68. To provide rotation clearance but with a minimum gap between rotor magnet 50 and the stator inside of motor housing 17 behind recess 18 and to avoid excess friction, the curvature of shell 64 is spaced from the curved wall of recess 18. Integral with frame 66 are a series of blades 71 configured so that upon rotation of the rotor-impeller 61, water is drawn in at the center of rotor-impeller 61 and then ejected out the sides. Rotation of rotor-impeller 61 is induced magnetically by motor 16 acting through the front of motor housing 17. This type of system for powering a centrifugal rotor-impeller is known in the art.

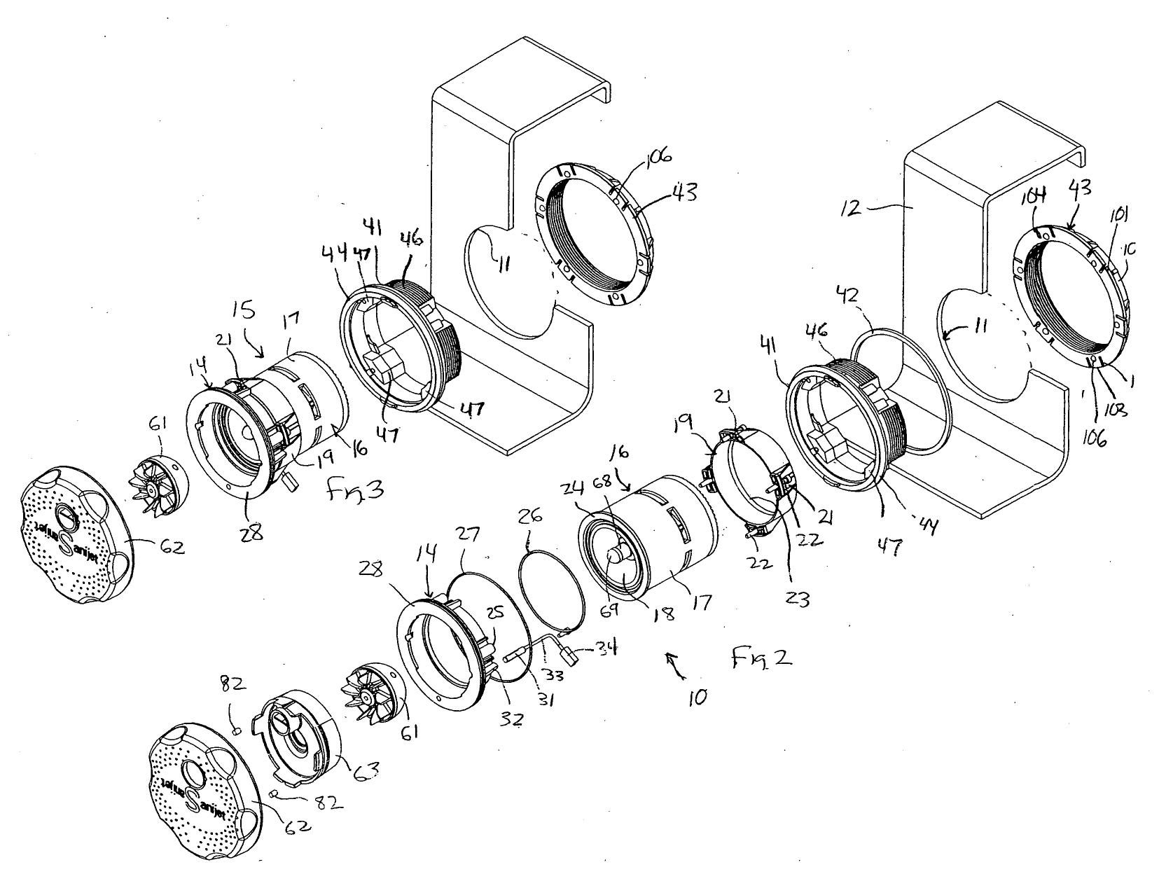

Cover 62 with flow guide 63 attached as described hereafter is secured over rotor-impeller 61. Flow guide (pump cap) 63 is removably attached to pump case 14. Flow guide 63 has a pair of curved lips 65 on opposite sides that fit though corresponding slots 70 on the inside of rim 28 of pump case 14. Once lips 65 are fully inserted into case 14, flow guide 63 is rotated 90 degrees into a locked position in which lips 65 are behind the inner edge of rim 28, the position shown in FIG. 2. This serves to hold pump cap 63 and pump case 14 together under pressure. Flow guide 63 contains channels to properly direct suction and discharge flow to and from impeller 61 as described further hereafter, and in combination with pump case 14 and rim 24 of motor housing 17 provides the pressure boundary of the pump due to impeller rotation.

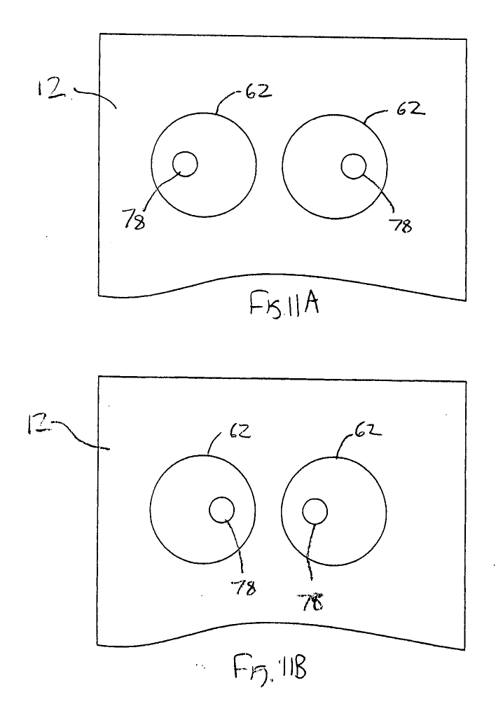

Cover 62 is a one piece plastic disk having an annular rim 73 that fits over the outside of bushing 41. It is rotationally positioned and mounted onto bushing 41 my means of a pair of detent projections 74 located 180° apart on the front face of rim 44 of bushing 41. Rounded, inwardly directed projections 76 on rim 73 releasably engage outwardly facing rounded grooves 77 in projections 74, enabling cover 62 to be hand tightened and removed. The placement of projections 74, 76 permits the cap to be mounted in either of two positions 180° apart, allowing the nozzle clearance opening 78 (provides clearance for 96), which is located off center, to be positioned above center (as shown), below center, or right/left, if bushing 41 is repositioned so that projections 74 are positioned left and right, or additional projections 74 are provided. As a result, in a whirlpool tub or spa according to the invention, jets can be placed in pairs on a tub wall 12 with nozzles in closer or further apart positions, as shown in FIGS. 11A and 11B. Use of detents in this manner also has advantages over a threaded on cap, in that bacteria tend to collect in the plastic threads.

Cover 62 further has intake holes 79 distributed around its surface. Holes 79 are preferably small and spaced apart over an outer annular portion of cover 62 to avoid user hair entrapment than can result when strong suction is created over a small area of the jet. There is also a small outer radial suction gap 90 (FIG. 7) between cover 62 and bushing 41. A pair of plastic posts 81 are formed on the inside of cover 62 near the outer rim 73. Posts 81 have rearwardly opening, optionally countersunk blind holes therein in which a pair of magnets 82 are inserted. When the jet is fully assembled as shown in FIG. 7, one of magnets 82 is in close proximity to the front of Hall effect sensor 31, spaced therefrom only by the thickness of front rim 28 of case 14, which may for example be from 0.1 to 0.2 inch. This provides for a more reliable sensor function that a design wherein the magnet and sensor are spaced apart by 0.6 inch or more, with a flux pin in between.

One post 81A corresponds to the nozzle position shown in the drawings, whereas the opposing post 81B aligns with sensor 31 when the nozzle opening 78 is placed in its alternative position as discussed above. By providing multiple magnets in this manner, the jet assembly can be made operable in two or more predetermined positions of cover 62 (and guide 63) relative to the rest of the jet assembly. For additional safety, it is preferred that sensor 31 be a unipolar Hall effect sensor, such that placing the cap on backwards will not allow the motor 16 to run, even if a magnet 82 is close to sensor 31.

Cover 62 snaps onto pump cap 63 which provides jar lid type handle for inserting pump cap and rotational lock of pump cap into pump case. It also prevents a user from touching the spinning blades 71 at pump caps suction opening 94. One of it's most important functions is to provide a large outer annular surface area for multiple small suction openings whose total area is greater than suction opening 94 below.

Flow guide 63 is a plastic insert in the shape of a two sided cup having a cylindrical outer wall 86 from the front of which a pair of opposed, undercut tabs 87 project. Tabs 87 resiliently engage complementary shaped grooves 88 in a pair of projections 89 formed in the inside of cover 62, inwardly from the intake holes 79. The user can squeeze tabs 87 in order to remove guide 63 for cleaning after cover 62 has been removed. Posts 81 have rails 80 thereon which slide into corresponding grooves 85 in flow guide 63 so that tabs 87 are in alignment with projections 89.

A bottom wall 91 of guide 63 is located in between the front and rear edges of outer wall 86, dividing guide 63 into a front flow chamber 92 and a back flow chamber 93. Chambers 92, 93 are in communication by means of a central hole 94 at the center of bottom wall 91, which hole is positioned directly over the center of rotor-impeller 61. Water flowing in the direction of the arrows in FIG. 7 passes through chamber 92 and hole 94 and is propelled outwardly by rotary movement blades 71 into the outer part of chamber 93. Guide 63 has a tube (discharge nozzle) 96 formed therein which fits closely inside of opening 78 and which communicates with chamber 93. The pump pressure forces the water in chamber 93 to jet out through tube 96 and into the tub. Tube 96 is open on one side in chamber 93, and the back of wall 91 is configured as a curved channel 95 to efficiently channel water through the nozzle.

Flow guide 63 is configured to guide water entering through holes 79 in cover 62 to the center of the device while minimizing pressure drop, and then allow it to flow out through the nozzle (tube 96) without any internal countercurrent flow between water entering the jet and water exiting the jet. When cover 62 and guide 63 are removed together, rotor-impeller 61 may then be manually removed for cleaning. Unlike a known design wherein the frame of the rotor-impeller includes a front enclosure that conceals the blades, the rotor-impeller 61 with exposed blades 71 can be cleaned more easily and thoroughly. However, since blades 71 are difficult to grasp, roller-impeller preferably has a central knob 100 that can be grasped by the user once cover 62 is removed. Since the blades 71 are exposed, it is especially important that motor 16 be cut off by sensor 31 when cover 62 is not in place.

It will also be noted from the foregoing that the user removes cover 62 by twisting it, which twisting can be in the same direction as the twisting action that would disengage the motor assembly 15 from flange bushing 41. To prevent this from happening, the force required to disengage the motor assembly 15 from its detents is considerably greater than the force needed to unlock cover 62, and may require use of a tool such as a spanner set in a pair of opposed notches 105 on the inside of rim 28 of case 14. The whirlpool jet as described herein can thus be partially taken apart for cleaning, or removed and replaced in its entirely if for example the motor fails, without need to access components on the outside of the tub wall, which is often covered by a tub skirt, wall, or the like.

Lock ring 43 in the preceding embodiment may be an ordinary threaded plastic ring comprising a front flange 101 with a flat surface for engaging the outside of the tub wall, and an internally threaded body 102 which tightens onto threaded end portion 46. As shown, ring 43 is further improved by providing a set of radially spaced arms 103 formed by radial cuts 104 part way through the width of flange 101. The insides of arms 103 have rounded projections 106 thereon which engage the outside of the tub wall 12 as shown in FIG. 1. The outside of a tub wall is often uneven, and arms 103 can flex to varying degrees as ring 43 is tightened, providing better locking engagement.

The foregoing embodiment is the presently preferred embodiment of the claimed invention. It will be readily apparent to one skilled in the art that many variations of the invention can be made without deviating from the scope of the claims. For example, the Hall effect sensor may be replaced by one or more light sensors, and the magnets by reflectors, with transparent plastic used where needed to allow light transmission. This and other modifications are considered within the scope of the appended claims.

1. A jet for use in a whirlpool tub or spa, comprising:
a motor assembly including an electric motor disposed inside a motor housing, which motor housing includes a frontwardly facing, water-tight recess;
means for mounting the motor assembly in a hole in a tub wall from inside of the tub;
a centrifugal pump assembly including a rotor-impeller having a rear, magnetically attractable rotor disposable in the recess of the motor assembly and a front set of blades;
a cover having water inlet and outlet openings removably securable over the centrifugal pump assembly; and
a sensor system which can be connected to the motor to shut off the motor when the cover is removed from the centrifugal pump assembly, including a sensor target disposed on a rear surface of the cover and a sensor disposed proximate the pump assembly, such that the sensor detects the sensor target only when the cover is secured over the centrifugal pump assembly in one or more predetermined positions.

2. The jet of claim 1, wherein the sensor is a Hall effect sensor and the sensor target is a magnet.

3. The jet of claim 2, wherein the sensor is a unipolar Hall effect sensor, such that placing the cover on backwards will not allow the motor to run, even if a sensor target magnet is close to the sensor.

4. The jet of claim 1, wherein two sensor targets are provided on the cover, whereby the cover can be secured in either of two predetermined positions in which the sensor target is proximate the sensor.

5. The jet of claim 2, wherein the pump assembly includes a tubular plastic pump case which fits around the front of the recess of the motor housing and has a front, radially outwardly extending rim, the Hall effect sensor is mounted behind the pump case rim, and the magnet is mounted so that it adjoins the pump case rim on the opposite side from the sensor.

6. The jet of claim 5, wherein the magnet is mounted in a post that projects rearwardly from a back surface of the cover.

7. The jet of claim 1, wherein the rotor-impeller blades are exposed on the front and side of the rotor-impeller.

8. The jet of claim 1, further comprising:
wherein the cover is removably secured over the centrifugal pump assembly by twisting in one of a clockwise or counterclockwise direction to secure the cover, and twisting in the other direction to release it; and
the motor assembly is secured in the hole in the tub wall by inserting and then twisting in the same direction as the cover, and released by twisting in the other direction and then removing it from the hole in the tub wall, the force required to remove release the motor assembly being greater than the force required to release the cover.

9. The jet of claim 8, wherein the cover may be released by hand, and a tool must be used to release the motor assembly from the hole.

10. A jet for use in a whirlpool tub or spa, comprising:
a motor assembly including an electric motor disposed inside a motor housing, which motor housing includes a frontwardly facing, water-tight recess;
means for mounting the motor assembly in a hole in a tub wall;
a centrifugal pump assembly including a rotor-impeller having a rear, magnetically attractable rotor disposable in the recess of the motor assembly and a front set of blades;
a cover removably securable over the centrifugal pump assembly, the cover having a plurality of small water inlet openings distributed about its surface and one or more off-center outlet openings; and
a sensor system which can be connected to the motor to shut off the motor when the cover is removed from the centrifugal pump assembly, including at least two sensor targets disposed on a rear surface of the cover and a sensor disposed on the pump assembly, such that the sensor detects one of the sensor targets only when the cover is secured over the centrifugal pump assembly in two or more predetermined positions, and wherein water flow direction from the outlet opening varies depending on which predetermined position the cover is secured in.

11. The jet of claim 10, wherein the sensor is a Hall effect sensor and the sensor target is a magnet.

12. The jet of claim 10, wherein the rotor-impeller blades are exposed on the front and side of the rotor-impeller.
